(19) United States
(12) Patent Application Publication
(10) Pub. No.: US 2006/0073324 A1
(43) Pub. Date: Apr. 6, 2006

(54) Exothermic film

(76) Inventors: David C. Otto, Kennett Square, PA (US); Lois J. Mabon, Landenberg, PA (US)

Correspondence Address: W. L. Gore & Associates, Inc., 551 Paper Mill Road, P.O. Box 9206, Newark, DC, 19714-9206, US

(21) Appl. No.: 10/959,519

(22) Filed: Oct. 5, 2004

(51) Int. Cl. B32B 5/22

(52) U.S. Cl. 428/317.9; 428/305.5

(57) ABSTRACT

In one aspect, the present invention provides an exothermic article comprising a film comprising an expanded polymer, said film having at least some porosity; and an exothermic composition disposed within said expanded polymer wherein said exothermic article is flexible. In a further aspect, the invention is a laminate comprising an exothermic layer, said exothermic layer comprising a film, said film comprising an expanded polymer having at least some porosity and an exothermic composition disposed within said expanded polymer, and an oxygen management layer disposed on at least one side of said exothermic layer. In another aspect, the invention is a laminate comprising: a film comprising porous expanded polytetrafluoroethylene and having a porosity of at least about 5%; an exothermic composition disposed within the porous expanded polytetrafluoroethylene, the exothermic composition comprising an electrolyte and at least about 10 wt % iron powder; and an oxygen management layer adjacent to the film, In this aspect, the oxygen management layer may comprise a film having a plurality of perforations.

### BACKGROUND OF THE INVENTION

The present invention relates to portable disposable warming devices. Specifically, the invention provides a disposable exothermic film having a variety of uses.

Numerous disposable warming devices use exothermic metal oxidation reactions as a portable heat source. Combinations of metal powders and an electrolyte are well known examples of exothermic compositions in which the oxidation reaction is a source of heat. Specifically, the oxidation of iron powder is an often-used source of heat for portable and therapeutic warmers and the like. The magnesium oxidation reaction produces more heat and is useful for portable food heaters. For example, U.S. Pat. No. 4,522,190 teaches the oxidation of “supercorroding” alloys of magnesium and iron to warm food. Devices using a metal oxidation reaction as a portable heat source are collectively referred to herein as “warmers.”

Most warmers include powdered reactants contained in some form of pouch. The reactants typically include an oxidizable metal and an electrolyte, but may also include catalysts, water retaining materials and other components. Because the exothermic reaction requires oxygen, the pouch is at least partially constructed of air permeable material. The air permeability of the pouch may be used to control the rate of oxygen that is available to react. The oxygen rate determines the maximum temperature and duration of heat production for the pack; with sufficient oxygen, warmers can achieve high temperatures for a short time. If the oxygen supply is limited, warmers maintain a relatively lower temperature, but maintain that temperature for more sustained periods.

Warmers that contain powders in a pouch have numerous disadvantages when used as portable body warming packs for therapeutic or other purposes. For example, the powdered reactants used in commercially available iron-oxidation warmers settle with gravity. Settling may slow the oxidation reaction and cause discomfort. Moreover, when the powder settles, contact area is limited which reduces the heat transfer efficiency. Perhaps most significantly, the iron particles harden and become quite stiff as oxidation proceeds. The powder grains agglomerate to become large and stiff as the individual particles connect by creating “bridges” of iron oxide between them. Thus, even if the packs initially contain relatively comfortable and conformable powders, by the end of their usefulness, the bags contain brittle gravel-sized particles or even solid “cakes” of rust. Finally, the packs are not customizable in size or shape. This lack of customizability leads to waste and further discomfort for many users.

Several attempts have been made to mitigate or avoid these problems by containing the powders within small compartments or distributing them within the voids of fabrics or plastic foams. To prevent settling of particles, for example, U.S. Pat. No. 5,425,975, uses an oxidizable metal powder dispersed within the interstices in a sheet-shaped substrate having irregularly arranged fibers. The metal powder is dispersed in the interstices among the fibers of the substrate and thus becomes supported by the fibers. Iron powder is spread over the surface of the substrate and vibrated so that the individual particles are distributed within the space between the substrate fibers. Similarly, U.S. Pat. No. 4,331,731 teaches vibrating exothermic particles into the voids found in a plastic foam.

The prior art has failed to satisfactorily address the aforementioned problems. Bridging problems between particles still occurs, which makes the warmers stiff. Moreover, most known warmers are contained in a non-customizable pouch. At best, the powders are only supported by fibers that prevent some settling and must be contained by an envelope or pouch. If the container is cut, the powder easily falls from the support causing mess and inconvenience. Accordingly, there is a need for a true exothermic film to address the problems of known exothermic bodies.

### SUMMARY OF THE INVENTION

In one aspect, the present invention provides an exothermic article comprising a film comprising an expanded polymer, said film having at least some porosity; and an exothermic composition disposed within said expanded polymer wherein said exothermic article is flexible.

In a further aspect, the invention is a laminate comprising an exothermic layer, said exothermic layer comprising a film, said film comprising an expanded polymer having at least some porosity and an exothermic composition disposed within said expanded polymer, and an oxygen management layer disposed on at least one side of said exothermic layer.

In another aspect, the invention is a laminate comprising: a film comprising porous expanded polytetrafluoroethylene and having a porosity of at least about 10%; an exothermic composition disposed within the porous expanded polytetrafluoroethylene, the exothermic composition comprising an electrolyte and at least about 50 wt % iron powder; and an oxygen management layer adjacent to the film, In this aspect, the oxygen management layer may comprise a film having a plurality of perforations.

In another aspect, the exothermic article includes an exothermic composition comprising metal powder and an electrolyte.

In a further aspect, the metal powder is bound within the expanded polymer.

In yet another aspect, the exothermic article further comprises a catalyst.

In still another aspect, the exothermic article includes a catalyst that is carbon. In this aspect, the carbon may be activated carbon.

In a further aspect, the exothermic composition further comprises a water retention material.

In another aspect, the exothermic article includes a water retention material that is selected from the group consisting of vermiculite, pearlite, zeolite, porous silicates, wood powder, wood flour, wood pulp, superadsorbent polymers including polysodium acrylate, activated carbon, cotton, paper, vegetable matter, and carboxymethylcellulose salts.

In yet another aspect, the expanded polymer comprises a synthetic polymer.

In yet another aspect, the expanded polymer comprises expanded PTFE.

In still another aspect, the expanded polymer comprises polyurethane.

In a further aspect, the expanded polymer comprises open pores.

In another aspect, the expanded polymer has a porosity of at least about 5%, about 20%, about 50% or about 80%.

In yet another aspect, the metal powder is selected from the group consisting of iron powder, aluminum powder, nickel powder and magnesium powder and alloys and mixtures thereof.

In a further aspect, the metal powder comprises iron powder.

In still another aspect the exothermic article comprises at least about 30 Wt %, 50 Wt %, or 90 Wt % iron powder.

In another aspect the invention provides a garment, wherein the garment includes an exothermic film.

In still another aspect, the invention provides a blanket, wherein the blanket includes an exothermic film.

### BRIEF DESCRIPTION OF THE DRAWINGS

FIG. 1 is a cross sectional view of one embodiment of the claimed invention.

FIG. 2 is a cross sectional view of one embodiment of the claimed invention showing optional oxygen management, insulative and heat reflective layers.

FIG. 3 is a scanning electron microscope photograph of a cross section of the exothermic film according to one aspect of the present invention. A porous matrix of nodes and fibrils is visible. The exothermic composition is within the matrix.

FIG. 4 shows the test apparatus for measuring heat capacity of exothermic films.

### DESCRIPTION

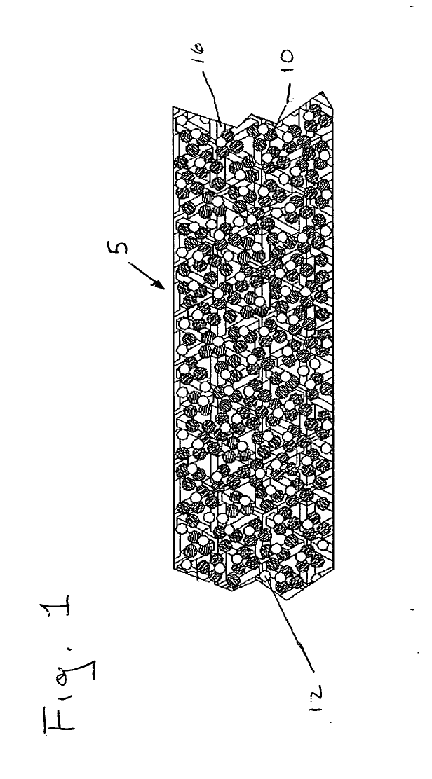

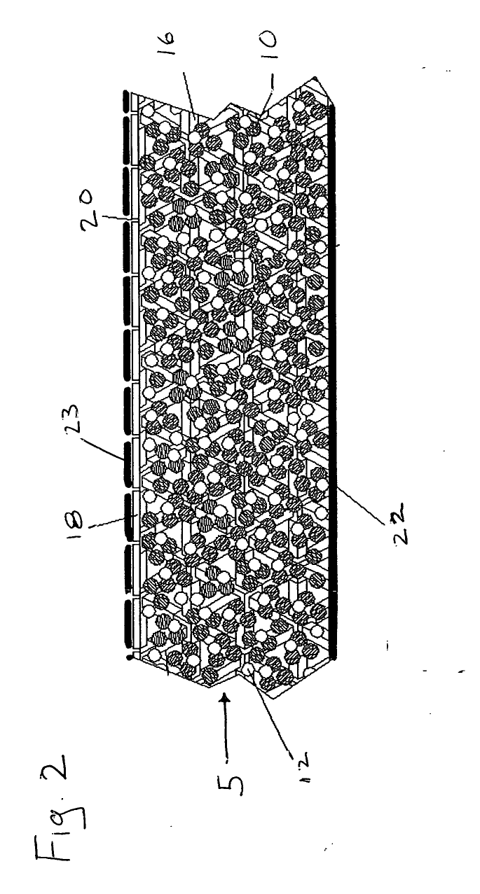

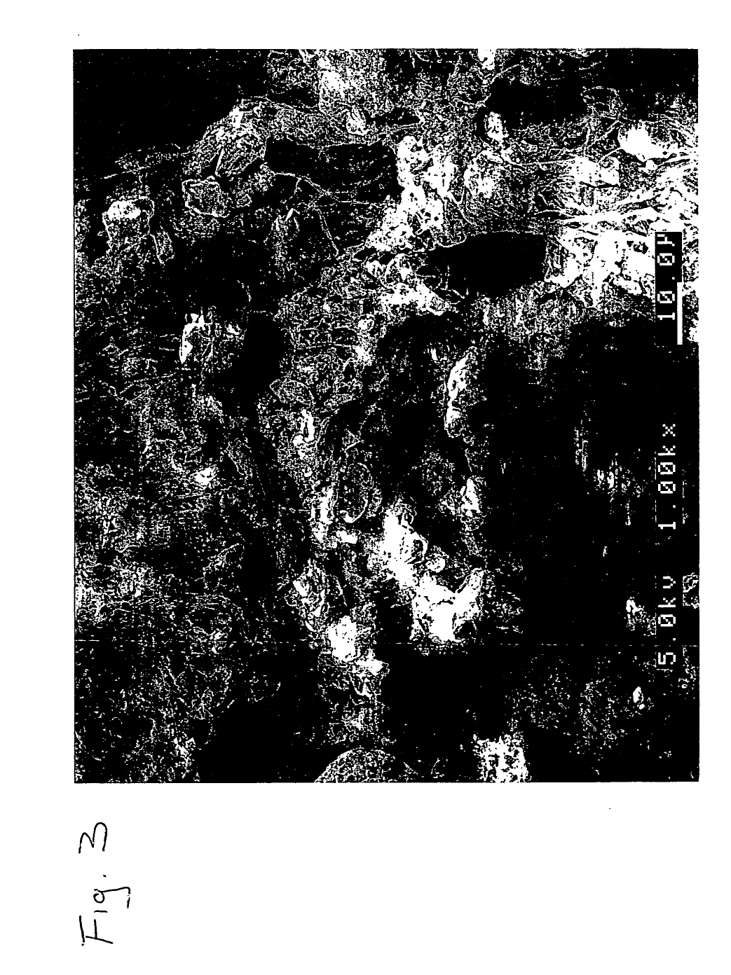

The invention discussed herein provides an exothermic film. As seen in FIGS. 1-3, the unique film 5 is a composite that includes an exothermic composition within an expanded polymer matrix. At least one component of the exothermic composition is first combined with the polymer in a slurry and coagulated. The coagulant is dried, pelletized and extruded. The extrudate may be a film, a tape or a sheet, or it may be a tube or fiber (collectively, a “film”). The extrudate is then expanded to create at least some porosity within the composite. At least some of the porosity is filled when the tape is then imbibed with an electrolyte. Optionally, an oxygen management layer 18 is provided to one or more sides of the tape. The oxygen management layer facilitates the controlled flow of oxygen to the exothermic composition. By selecting the appropriate materials and permeability, the film temperature and reaction duration can be controlled by the oxygen management layer. The oxygen management layer may also serve to inhibit evaporation of water from the aqueous electrolyte. However, the invention also may include a separate water management layer for this purpose.

The exothermic compositions useful in the present invention include well-known combinations of materials that react to produce heat in the presence of air. Preferably, the exothermic composition includes oxidizable metal 12. Suitable metals may include iron, aluminum, magnesium and other oxidizable metals and alloys or mixtures thereof. However, iron is the preferred metal for the exothermic composition.

Most preferably, the metal is powdered. For example, iron powder of 1000 micrometers or less is particularly suited for use in the present invention. It is important that the average size of the particles not be so large as to reduce the flexibility and softness of the exothermic film. Most preferably, the average particle diameter is about 100 micrometers or less.

The exothermic composition further comprises electrolyte 16. An electrolyte provides the necessary conductivity for the exothermic reaction to proceed. The present invention may include well-known aqueous electrolytes. For example, aqueous solutions of NaCl are preferred because such solutions are both effective and inexpensive. The amount and concentration of electrolyte should be sufficient to permit all of the metal powder to oxidize. However, it will be understood that excess liquid may interfere with oxygen diffusion to the metal surface, slowing the reaction and reducing heat output. Thus, in some embodiments, the amount of liquid may be chosen to optimize the rate of metal oxidation and the desired heating profile.

If the electrolyte is an aqueous NaCl solution, for example, useful electrolyte concentrations may be from about 2% to about 20% or higher. Known exothermic compositions of iron powder and aqueous NaCl solutions may contain from about 5% to about 50% wt % water. Such concentrations are useful in the exothermic film of the present reaction. However, one of skill in the art will understand that other electrolytes will also function well without departing from the invention claimed.

Other ingredients may optionally be included in the exothermic composition. For example, a catalyst 10 is often used to promote the oxidation reaction. A “catalyst” is a substance that modifies or increases the rate of the oxidation reaction without being consumed in that reaction. For example, carbon is well known as a catalyst of the iron oxidation reaction. Carbon may serve not only as a catalyst, but also as a water retention ingredient.

Optionally, a water retention material may be a separate component of the exothermic composition. Water retention materials are useful to promote complete oxidation of the metal powder. As used herein, a “water retention material” is a material suitable for storing water and for releasing it as necessary to maintain the oxidation reaction. Suitable water retention materials include: vermiculite, pearlite, zeolite, porous silicates, wood powder, wood flour, cotton, paper, vegetable matter, and carboxymethylcellulose salts.

The polymer used in the exothermic films of the present invention must be expanded to provide at least some porosity. The porosity provides a mechanism for storage of electrolyte and may also provide air pathways that promote a more complete reaction of the exothermic materials. Expansion may also provide increased flexibility by isolating the exothermic reactant particles. As a result of expansion, the exothermic particles are somewhat isolated from one another. Such isolation within the polymer matrix may reduce the formation of metal oxide “bridges” between reacting particles that can cause increasing stiffness of the exothermic film as the reaction proceeds.

As used herein, “expansion” is a process by which the density of a polymer is reduced from an initial density, before processing, to a final density, after processing. An “expanded polymer” means a polymer that has been processed by expansion to reduce its density.

The expanded polymers useful in the present invention may include foamed polymers, such as foamed thermoplastics, including polyolefins, and mechanically expanded plastics. Preferably, the expanded polymers will have an open cell structure. As used herein, “open cell” foams refers to those foams in which individual cells are predominantly interconnected throughout. Open cell structures simplify the imbibing with electrolyte.

Where the expanded polymer of the present invention is a foamed polymer, the polymer is mixed with an exothermic composition before expansion. By mixing an exothermic composition with the polymer before expansion, at least some of the exothermic composition is disposed and may be bound within the polymer matrix. Foamed plastics include polymeric foam materials produced by mechanical, chemical or physical means. Such methods include, without limitation: thermal decomposition of chemical blowing agents, mechanical whipping of gasses (frothing) into a polymer system entrapping gas bubbles in the polymer matrix, volatilization of gasses or low-boiling point liquids within the polymer mass, and expansion of dissolved gasses in a polymer matrix upon reduction of pressure in the system, removal of sacrificial components within a polymer matrix and other known means for reducing the density of a polymer.

For example, many polyolefins are readily expanded by extrusion foaming. In extrusion foaming, a blowing agent is mixed with molten polymer. The release of the blowing agent upon reduced pressure at the extruder die expands to produce a cellular foam structure within the polymeric matrix. The foam is most preferably open cell foam such as polyurethane foam, which will help to facilitate imbibing with an electrolyte.

The foam may also be an elastomeric foam, such as sponge rubber, neoprene, or silicone elastomeric foam. Sponge rubber includes cellular materials made by sheeting, molding or extruding compounded gum rubber using a blowing agent.

Preferably, the expanded polymer is a fluorinated polymer. Most preferably, the expanded polymer is porous expanded PTFE. Porous expanded PTFE, such as that made in accordance with U.S. Pat. Nos. 3,953,566; 3,962,153; 4,096,227; and 4,187,390, comprises a porous network of polymeric nodes and interconnecting fibrils. These kinds of material are commercially available in a variety of forms from W. L. Gore & Associates, Inc., Newark, Del.

Expanded PTFE is formed when PTFE is rapidly expanded by stretching in at least one direction in the manner described in the above listed patents. The resulting expanded PTFE material achieves a number of exceptional properties, including exceptionally high flexibility, and conformability.

As the term “expanded PTFE” is used herein, it is intended to include any PTFE material having a node and fibril structure, including in the range from a slightly expanded structure having fibrils extending from relatively large nodes of polymeric material, to an extremely expanded structure having very long fibrils interconnected by small nodes. The fibrillar character of the structure is identified by microscopy. While the nodes may easily be identified for some structures, many extremely expanded structures consist almost exclusively of fibrils with very small nodes.

The PTFE may be expanded to any degree that is adequate to provide sufficient porosity to store enough electrolyte for the complete oxidation of the reactants. Preferably, however, the PTFE is expanded at least at a two to one ratio. Although the degree of expansion is not critical, expansion provides flexibility and softness, in addition to electrolyte capacity. Expansion of less than two to one may result in less flexible exothermic films. If the expansion is too great, however, the film may break.

In the exothermic films of the present invention, the expanded polymer is filled with at least some of the exothermic reactants. Filled PTFE may be prepared in several ways known to those of skill in the art. For example, methods of preparing filled ePTFE is taught in U.S. Pat. No. 4,985,296 to Mortimer, which is herein incorporated by reference.

The inventive exothermic film 5 may be covered by or laminated to a functional layer, such as an oxygen management layer. The oxygen management layer may comprise virtually any material that limits the rate of oxygen flow from one side of the layer to the other, opposite side. The oxygen management layer may be impermeable to oxygen and have perforations therein to permit airflow. Alternatively, the oxygen management layer may be made from highly oxygen permeable materials. Such materials also may be coated to alter the oxygen permeability. In one example, the film may be an oxygen impermeable single or double-sided adhesive tape or film. The adhesive is perforated to allow air to reach the reactants, and may be used to attach the film to a body or to clothing. Preferably, the oxygen management layer comprises a polymer film or membrane, such as an acrylic, polyamide, polyacrylate or polyurethane film having perforations 20 therein.

However, the oxygen management layer may also comprise a woven or non-woven fabric. The fabric may be made from natural or synthetic fibers. For example, thermoplastic resins may be used to make a spun bond or melt blown non-woven fabric layer.

The oxygen management layer is preferably bonded to the exothermic film to form an exothermic laminate. However, the oxygen management layer is not necessarily attached. In some applications, it may be useful to simply place the exothermic film directly into an air permeable pouch, such as is used in traditional warmers. The pouch or exothermic film may be incorporated into a blanket or a garment, such as a jacket, vest, glove, wristband, sock, boot hat or hood.

The thickness of the air permeable material may vary, depending on the material chosen, but typically will be from about 0.1 mm to about 0.5 mm. If the oxygen management layer is bonded to the exothermic film, thicker materials may limit the flexibility of the exothermic laminate.

The oxygen management layer may have different oxygen permeability at different regions on the surface of the layer. Variable permeability enables the film to be warmer in some areas than others. For example, the film may be hottest at its center and gradually be less hot towards the edges. This may be advantageous in certain therapeutic applications. Alternatively, the oxygen management layer may have variable permeability when used in a garment to provide more heat to one part of the body than to another. In other applications, multiple removable oxygen management layers may enable the user to select the heating level and duration they desire. By peeling away one or more removable oxygen management layers, the user can cause the exothermic film to react more quickly and provide more heat for a shorter period.

The exothermic film may also be advantageously combined with other functional layers. Such layers may include, without limitation insulating layers 22 and heat reflective layers 23 and combinations thereof. For example, known insulating layers, such as aerogels may be used to prevent heat loss to the atmosphere. Such insulating layers may be combined with one or more known heat reflective layers, such as a metal foil to further prevent heat loss. Functional layers may serve multiple functions. For example, a single layer constructed of perforated metal foil may serve as an oxygen management layer, water management layer, and heat reflective layer. Functional layers may be positioned on one or more sides of the exothermic film. Moreover, functional layers may be removable. Removable functional layers can be used to vary intensity of heat.

### EXAMPLE 1

A slurry containing 0.99 lbs. activated carbon in deionized water was prepared. The slurry was agitated at 1500 rpm for three minutes using a low shear blade. Iron powder was added to the slurry and mixing continued for another three minutes at 1500 rpm. The final slurry contained 3.97 lbs. iron powder.

An aqueous PTFE dispersion was rapidly poured into the mixing vessel. The dispersion was a Teflon® 3636 dispersion containing 24.1% solids polytetrafluoroethylene obtained from duPont Corporation, Wilmington, Del. A coagulation promoter was added simultaneously with the PTFE in the form of a 0.4% deionized water solution. Upon addition of the PTFE and coagulation promoter, the mixture was self-coagulating and co-coagulation was completed rapidly.

The coagulum was dried in an oven at 150° C. for 18 hours. The oven was first nitrogen purged and then a vacuum was applied during drying. After drying, moisture of 0.6% by weight remained. The material was chilled to −6° C. The chilled cake was hand ground using a tight, circular motion and downward force through a 0.635 cm (¼″) mesh stainless steel screen.

Mineral spirits were added as a lubricant at 0.350 lbs. per lb. The mix was allowed to sit for 12 hours before it was tumbled and screened through a 0.64 cm (¼″) screen.

Two four-inch diameter pellets were formed from the lubed coagulum. A pelletizing device applied a vacuum for 5 minutes. Next, the pellets were compressed under a pressure of 800 psi for one minute. The pellet was then heated in a sealed tube for 6 hours at 49° C.

The pellets were then formed into tapes. Each pellet was extruded into a 2.16 mm (85 mil) thick tape in a 4″ ram extruder. The extrusion rate was 12 gpm. The extruder barrel and die were both heated to 49° C. The tape was then calendared through heated rolls to achieve a final thickness of 0.51 mm (20 mils). The lubricant was then evaporated by running the tape across rolls heated to 200° C.

The filled tape was expanded by stretching in the machine direction twice. First, the tapes were expanded at a 2 to 1 ratio, at 240° C. and 32 m/min. output speed. Second, the samples were expanded at a 3 to 1 ratio, at 240° C. and 29 m/min. output speed. he expanded tape was then compressed to 0.03 mm by running it between heated rolls.

The filled tape samples were imbibed with an 8% NaCl solution in water. Imbibing was performed by submerging the samples in the solution while a vacuum was applied to the top side of the tape. The solution was at room temperature during imbibing and the vacuum applied was 12 inches Hg. After imbibing, the samples were sealed in airtight metal foil bags to prevent the iron oxidation reaction from proceeding until the exothermic film was to be used.

### Test Methods

The exothermic film of Example 1 was evaluated for heat output using the following method:

First, the imbibed tapes were die cut into 2″ diameter discs and weighed. Next, a 2″ adhesive disc was fitted on both sides of the sample. Each adhesive disc was perforated to allow air to reach the exothermic film. The perforations were made with a pin and were about evenly distributed over the surface of each disc. Sufficient perforations were provided so that approximately 0.1 percent of the disc surface was open.

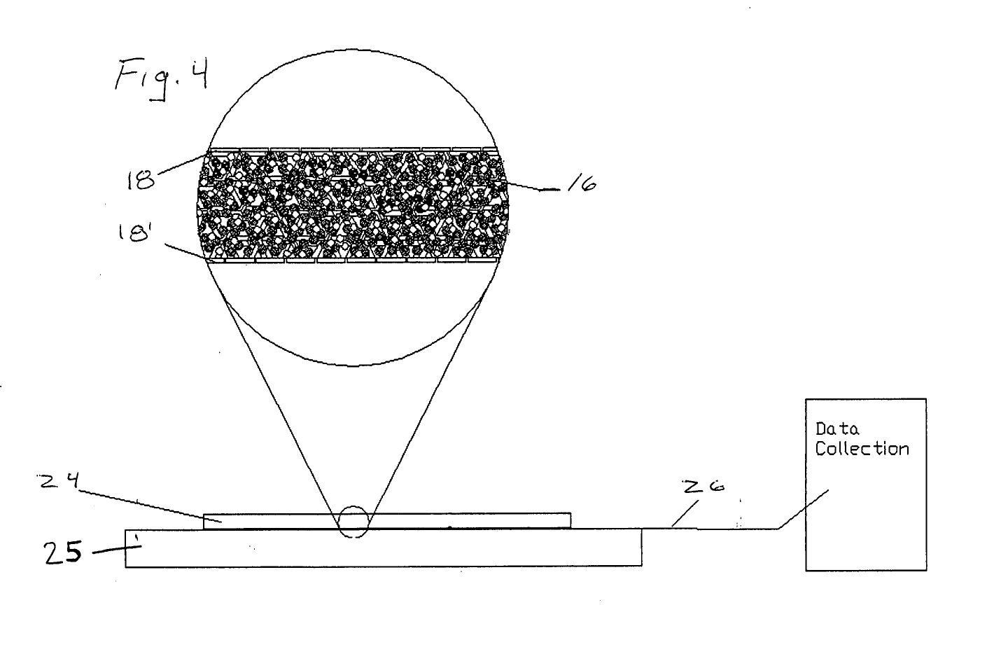

As seen in FIG. 4, the disc 24 was placed on an Omega type J thermocouple 26 (available from Omega Engineering, Stamford, Conn.) such that the thermocouple was located approximately at the center of the disc. The thermocouple used a 0.005″ diameter wire. To prevent heat loss to the environment, the disc and thermocouple were placed on the highly insulative surface 25 of an open topped Dewar flask. The thermocouple was adjacent to the surface of the flask. Moderate pressure assured contact between the insulated surface, the thermocouple and the disc. Temperature was recorded every 2 minutes until the disc produces a temperature that is 3° C. above the testing area ambient temperature of about 22° C.

When exposed to air, a disc constructed in accordance with Example 1 maintained a temperature above 25° C. at the thermocouple for 332 minutes and reached a maximum temperature of 36.8° C. Significantly, the exothermic disk was soft and conformable before use and remained so during and after testing.

We claim:

1. An exothermic article comprising:
a) a film comprising expanded polymer, said film having at least some porosity; and
b) an exothermic composition disposed within said expanded polymer, wherein said exothermic article is flexible.

2. The exothermic article of claim 1, in which said exothermic composition comprises metal powder and electrolyte.

3. The exothermic article of claim 2 in which said metal powder is bound within said expanded polymer.

4. The exothermic article of claim 2, in which said exothermic composition further comprises catalyst.

5. The exothermic article of claim 4, in which said catalyst is carbon.

6. The exothermic article of claim 5, in which said carbon is activated carbon.

7. The exothermic article of claim 2, in which said exothermic composition further comprises water retention material.

8. The exothermic article of claim 7 in which said water retention material is selected from the group consisting of vermiculite, pearlite, zeolite, porous silicates, wood powder, wood flour, wood pulp, cotton, paper, activated carbon, vegetable matter, and carboxymethylcellulose salts, super absorbent polymers, and polysodium acrylate.

9. The exothermic article of claim 1 in which the expanded polymer comprises synthetic polymer.

10. The exothermic article of claim 9, in which said expanded polymer comprises expanded PTFE.

11. The exothermic article of claim 9, in which said expanded polymer comprises polyurethane.

12. The exothermic article of claim 1, in which said expanded polymer comprises open pores.

13. The exothermic article of claim 1, in which said expanded polymer has a porosity of at least about 5%.

14. The exothermic article of claim 1, in which said expanded polymer has a porosity of at least about 20%.

15. The exothermic article of claim 1, in which said expanded polymer has a porosity of at least about 50%.

16. The exothermic article of claim 1, in which said expanded polymer has a porosity of at least about 80%.

17. The exothermic article of claim 2, in which the metal powder is selected from the group consisting of iron powder, aluminum powder, nickel powder and magnesium powder and alloys and mixtures thereof.

18. The exothermic article of claim 17, in which the metal powder comprises iron powder.

19. The exothermic article of claim 18 in which the exothermic article comprises at least about 10 Wt % iron powder.

20. The exothermic article of claim 18 in which the exothermic article comprises at least about 50 Wt % iron powder.

21. The exothermic article of claim 18 in which the exothermic article comprises at least about 90 Wt % iron powder.

22. A laminate comprising:
a) an exothermic layer, said exothermic layer comprising film, said film comprising an expanded polymer and having at least some porosity, and an exothermic composition disposed within said expanded polymer, and
b) an oxygen management layer disposed on at least one side of said exothermic layer.

23. The laminate of claim 22, in which wherein said exothermic composition comprises metal powder and electrolyte.

24. The laminate of claim 23, in which said exothermic composition is bound within said expanded polymer.

25. The laminate of claim 22, in which the exothermic composition further comprises a catalyst.

26. The laminate of claim 25, in which said catalyst is carbon.

27. The laminate of claim 26, in which said carbon is activated carbon.

28. The laminate of claim 23, in which said exothermic composition further comprises water retention material.

29. The laminate of claim 28 in which said water retention material is selected from the group consisting of vermiculite, pearlite, zeolite, porous silicates, wood powder, wood flour, wood pulp, cotton, paper, activated carbon, vegetable matter, and carboxymethylcellulose salts, super adsorbent polymer, and polysodium acrylate.

30. The laminate of claim 22, in which the expanded polymer comprises synthetic polymer.

31. The laminate of claim 30, in which said expanded polymer comprises expanded PTFE.

32. The laminate of claim 30, in which said expanded polymer comprises polyurethane.

33. The laminate of claim 22, in which said expanded polymer comprises open pores.

34. The laminate of claim 22, in which said expanded polymer has a porosity of at least about 5%.

35. The laminate of claim 22, in which said expanded polymer has a porosity of at least about 20%.

36. The laminate of claim 22, in which said expanded polymer has a porosity of at least about 50%.

37. The laminate of claim 22, in which said expanded polymer has a porosity of at least about 80%.

38. The laminate of claim 23, in which said exothermic composition comprises metal powder selected from the group consisting of iron powder, aluminum powder, nickel powder and magnesium powder and alloys and mixtures thereof.

39. The laminate of claim 38, in which the metal powder comprises iron powder.

40. The laminate of claim 39 in which the laminate comprises at least about 10 Wt % iron powder.

41. The laminate of claim 39 in which the laminate comprises at least about 50 Wt % iron powder.

42. The laminate of claim 39 in which the laminate comprises at least about 90 Wt % iron powder.

43. The laminate of claim 22, further comprising an oxygen management layer disposed on at least two surfaces of the exothermic layer.

44. The laminate of claim 22 in which the oxygen management layer comprises polymeric non-woven material.

45. The laminate of claim 22 in which the oxygen management layer comprises polymeric membrane.

46. The laminate of claim 22 in which the oxygen management layer comprises impermeable material having a plurality of perforations.

47. The laminate of claim 22 in which the oxygen management layer has at least a first region and a second region and the oxygen permeability of the first region is higher than the oxygen permeability of the second region.

48. The laminate of claim 22, further comprising an insulative functional layer.

49. The laminate of claim 22, further comprising a heat reflective functional layer.

50. The laminate of claim 22, further comprising at least one removable functional layer.

51. The laminate of claim 22, further comprising at least one removable oxygen management layer.

52. A laminate comprising:
a) a film comprising porous expanded polytetrafluoroethylene having a porosity of at least about 10%;
b) an exothermic composition disposed within said porous expanded polytetrafluoroethylene, said exothermic composition comprising electrolyte and at least about 50 wt % iron powder; and
c) an oxygen management layer adjacent to the film, said oxygen management layer comprising an impermeable film having a plurality of perforations.

53. A garment comprising an exothermic composite film, said exothermic composite film comprising an expanded polymer having at least some porosity and exothermic composition disposed within said expanded polymer.

54. The garment of claim 53 in which said garment is selected from the group consisting of a shirt, a vest, a jacket, a coat and pants.

55. The garment of claim 53, in which said garment is adapted to be worn on a human hand.

56. The garment of claim 55, in which said garment is selected from the group consisting of a glove, a wristband and a mitten.

57. The garment of claim 53, in which said garment is adapted to be worn on a human head.

58. The garment of claim 57 in which said garment is selected from the group consisting of a hat, a hood, a headband and an earmuff.

59. The garment of claim 53, in which said garment is adapted to be worn on a human foot.

60. The garment of claim 59 in which said garment is selected from the group consisting of a sock, a boot and a shoe.

61. The use of the exothermic article of claim 1 in a garment.

62. The use of the laminate of claim 22 in a garment.

63. The use of the laminate of claim 22 in a blanket.
